(19) United States
(12) Patent Application Publication
(10) Pub. No.: US 2009/0234704 A1
(43) Pub. Date: Sep. 17, 2009

(54) SYSTEM AND METHOD FOR QUANTIFYING AND USING VIRTUAL TRAVEL MILEAGE

(76) Inventors: Larry E. Roher, Manhasset, NY (US); Robert Daniel Deadwyler, Roswell, GA (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/404,726

(22) Filed: Mar. 16, 2009

Related U.S. Application Data
(60) Provisional application No. 61/036,684, filed on Mar. 14, 2008.

(51) Int. Cl. G06Q 10/00; G06Q 30/00; G06Q 50/00

(52) U.S. Cl. 705/9; 705/30; 705/14

(57) ABSTRACT

A conference scheduling device automatically collects data such as call detail records of a conferencing session from a collaborative conference unit and associates the data to each of a plurality of conference attendees. The data is converted into mileage credit for the conference attendees. Rewards may be redeemed from the accumulated mileage credit.

### CROSS-REFERENCE TO RELATED APPLICATIONS

This application claims the benefit of U.S. Provisional Application No. 61/036,684, filed on Mar. 14, 2008, which is incorporated by reference herein in its entirety.

### FIELD OF THE INVENTION

The present application relates generally to collaborative conferencing and more particularly to quantifying and using virtual travel mileage, for instance, to reward users for not traveling.

### BACKGROUND OF THE INVENTION

Business traveling is expensive to both employers and employees in terms of both time and cost. For example, besides the normal cost and time required for traveling, the ever rising gas prices, airport delays, heavy traffic volume and jet lag invariable add to the burden of a trip. Such disruption also may reduce employee production. Extensive use of traveling also is not friendly to the global environment. Usage of travel vehicles, e.g., automobiles, airplanes, trains, etc. results in emitting more carbon dioxide or other greenhouse gases that are postulated to be contributing factors of the current global warming crisis.

Many companies or employees choose to use conferencing systems for conducting meetings among persons located remotely from one another. Currently, however, there is no clear rewards program or incentive for employees to forego traveling and instead use a conferencing system. Accordingly, it would desirable to have a system and method that would encourage the employees as well as employers to utilize more conferencing systems and reduce the actual traveling.

### BRIEF SUMMARY OF THE INVENTION

A method and system for quantifying and using virtual travel mileage, for instance, as a rewards program, are provided. The method, in one aspect, may comprise automatically collecting data associated with a conferencing session. The data, in one aspect, may include at least call detail records of the conferencing session. The method may also include converting the collected data into mileage credits, and establishing rewards for exchanging with the mileage credits. In another aspect, the method may also include converting the collected data into carbon credits.

A system for quantifying and using virtual travel mileage, in one aspect, may comprise one or more collaborative conference units operable to maintain a conferencing session. One or more conference scheduling devices may be operable to automatically collect call detail records of a conferencing session from one or more of the collaborative conference units or other devices that may be utilized to compile usage data of collaboration devices. A computer server may be operable to automatically receive data associated with the call detail records or other like records and convert the data into mileage credits. In another aspect, the computer server may be further operable to convert the data into carbon credits.

A program storage device readable by a machine, tangibly embodying a program of instructions executable by the machine to perform methods described herein may also be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is an architectural diagram illustrating various system components that enable tracking and calculation of virtual travel mileage and/or rewards in one embodiment of the present disclosure.

FIG. 2 is another architectural diagram showing multiple collaboration scheduling products or platforms working in conjunction with a single virtual travel mileage computer server or platform.

FIG. 3 is a flow diagram illustrating a method of tracking virtual travel mileage in one embodiment of the present disclosure.

### DETAILED DESCRIPTION

A system and method of the present disclosure in one embodiment collect data or records associated with video and/or audio conferences conducted by users, and convert the data into redeemable award points. In one embodiment of the present disclosure, each time an employee utilizes video and/or audio conferencing or the like in lieu of traveling for a business purpose, an amount of credits determined by the system are contributed to that employee's individual virtual travel mileage and/or rewards account. The credits earned and deposited into these accounts may be redeemed by each employee, for example, for rewards (e.g., merchandise) or the like made available by the employer. The collected data or records of such audio/visual conferences are also converted into or used to compute the amount of carbon credit that can be credited to the employer.

Briefly, carbon credit refers to a component of national and international emissions trading schemes that have been implemented to mitigate global warming. Such emissions trading schemes provide a way to reduce greenhouse effect emissions on an industrial scale by capping total annual emissions and letting the market assign a monetary value to any shortfall through trading. Credits can be exchanged between businesses or bought and sold in international markets at the prevailing market price. Credits can be used to finance carbon reduction schemes between trading partners and around the world. Additional information on carbon credits are found, for example, in Wikipedia™, a Web-based free encyclopedia.

In one embodiment of the present disclosure, the managing and tracking functionality for virtual travel mileage or virtual travel rewards accounts works in conjunction with scheduling software that can schedule, launch, and track all video conferences (or audio conferences or the like) and meetings. An example of such software may include myVRM™ scheduling software developed by Interactive Ideas in Westbury, N.Y. myVRM™ allows anyone in an organization to login under an established access level to automate and streamline the process of recording the qualifying program credits. Approval requirements may be set to secure rooms, bridge ports, and overall system use. Once reserved, the reporting mechanism may then allocate the accrued credits to each employee for management. Other scheduling software may be used to implement the method of collecting and managing the data associated with the conferences.

In one aspect, employees benefit from receiving a portion of the time, money and productivity saved by utilizing videoconferencing, and turning that into cash or other rewards through a redemption program. In addition, employers may be eligible for carbon credits for every credit earned as a result of the reduction in carbon emission from its employees not traveling—i.e., the non-use of automobiles, airplanes, trains, and others. By reducing the amount of its employees' actual travel, companies can take a role in environmental preservation.

The system and method of the present disclosure in one embodiment quantifies the exact amount of travel saved by a person and/or company when utilizing a non-travel solution to attend meetings. As described above, the system and method of the present disclosure in one embodiment may operate in conjunction with a collaborative scheduling program. For instance, the collaborative scheduling program may manage and track an accounting of the savings realized when the collaborative scheduling is utilized in place of traveling.

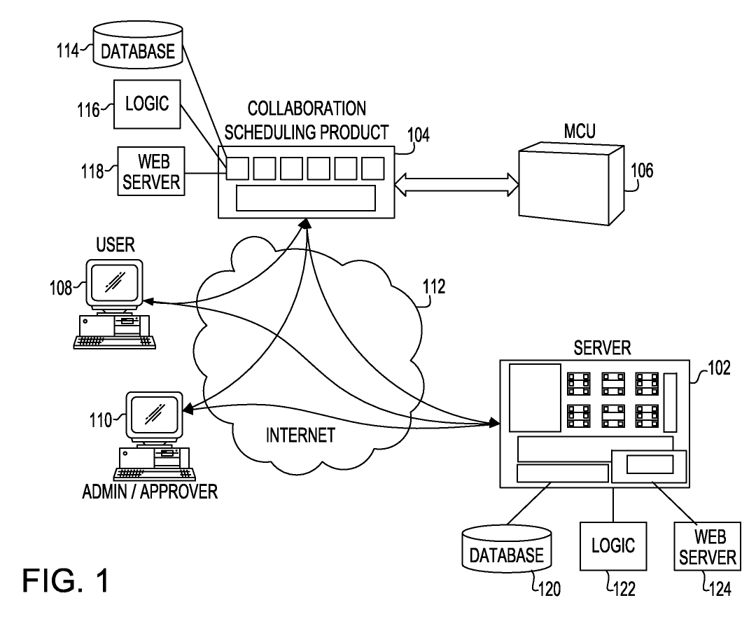

FIG. 1 is an architectural diagram illustrating various system components that enable tracking of saved travel mileage, i.e., virtual travel mileage. In this embodiment, the scheduling, editing, managing, launching of collaborative conferences and administration of components associated with the use of collaborative conferencing, may be maintained within the utility of a collaborative scheduling product 104 such as the myVRM™. A computer server or platform 102 (e.g., referred to herein as virtual travel mileage server) may manage and/or provide functions such as the organization of the company and employee profiles, allocation of a proper quantity of reward points to each employee for each conference attended, supervision and approval of the rewards assigned, redemption of the rewards, and the calculation of carbon credits accrued by the company resulting from the use of collaborative conferencing in place of travel.

The collaborative scheduling product 104 is a conference scheduling device that may comprise generally a web server 118, program logic 116, and database server 114. The program logic 116 may be logic or algorithm executable on a processor of the conference scheduling device or the like. The collaborative scheduling product 104 manages a database of users that are authorized to schedule collaborative conferences. Users (e.g., 108) may schedule, edit, and/or control collaborative conferences utilizing the collaborative scheduling product 104. The collaborative scheduling product 104 maintains a communication patn to multipoint conferencing units (MCUs), e.g., 106, and launches collaborative conferences to collaboration multipoint conferencing units (MCU) 106.

The communication path that is maintained between the collaborative scheduling product 104 and the multipoint conferencing units (MCU) 106 may be an Internet Protocol (IP) connection through which the collaborative scheduling product 104 transmits conference scheduling, conference launch, and conference control utilizing the application programmers interface library defined by each (MCU) 106 vendor. This may be a data/information communication path to deliver instructional information between (MCU) 106 and collaborative scheduling product 104. For example, the collaborative scheduling product 104 may transmit information to the multipoint conferencing units (MCU) 106. This information, for example, may be a command to the multipoint conferencing units (MCU) 106 to start a conference supporting five videoconferencing endpoints and twelve users 108. As another example of communication, the collaborative scheduling product 104 may transmit information to the multipoint conferencing units (MCU) 106 to change the video display of the videoconferencing endpoints.

The collaborative scheduling product 104 also may manage a database of information about the conducted and scheduled conferences, for instance, stored in its database server 114. For instance, the collaborative scheduling product 104 retains the information regarding the scheduled attendees for each conference; captures the call detail records (CDR) from the MCU 106. The collaborative scheduling product 104 may also append the scheduled conference with the CDR of the MCU to validate the conference. For example, when a conference is scheduled the collaborative scheduling product 104 is providing a command structure to be passed to the (MCU) 106. This is only information of what is scheduled and not what may actually transpire when the scheduled conference is held. For instance, the conference may last for a shorter or longer period of time than scheduled, locations and/or participants may be added after the conference begins, some of the locations and/or participants may leave early or arrive late. Therefore, to insure accuracy of information being sent from collaborative scheduling product 104 to virtual travel mileage server 102 for collection of rewards miles, the information derived in the collaborative scheduling product 104 and the call detail records (CDR) generated by each conference in (MCU) 106 are compared and adjusted so that the information being accumulated in virtual travel mileage server 102 is an accurate representation of scheduled and occurred conferences. The collaborative scheduling product 104 also manages a communications path to the virtual travel mileage server 102.

Briefly, Multipoint Conferencing Unit (MCU) 106 is a device that manages a multipoint conference by connecting the multiple sites and stations in the same videoconference. The MCU 106 can be used in conjunction with a Gateway to connect H.320 and H.324 videoconference end-points. The MCU 106 combines video, audio and data streams from multiple conference end-points into one multi-location, interactive session. The MCU 106 functions as a collaboration multipoint conferencing unit. The MCU 106 provides for videoconference and data sharing feature and functionality (e.g., videoconferencing feature that permits conference participants to display information from a PC onto the videoconference display), and maintains date and time stamped records, called CDR, for each conference. An example of conferencing systems are described in U.S. Pat. Nos. 7,292,544 and 7,426,193, which are incorporated herein by reference in their entirety.

A user at a user station 108 may have an assigned user account in both collaborative scheduling product 104 and virtual travel mileage server 102. The user, for example, using the user station 108 such as a personal computer, a laptop, or other computing devices may schedule conferences on the collaboration scheduling product 104. The user also has login read-only privileges to his or her account in virtual travel mileage. The user may be an employee of a company that registered with the virtual travel mileage server 102.

An administrator or approver at an approver station 110 may administer and approve the virtual travel mileage accounts and associated data. For example, in one embodiment, an approver checks user's rewards for accuracy so that the user is not receiving the rewards in error. This approval process may be useful since the reward data may be used to calculate carbon credits for companies. An administrator or approver may be an employee of a company and has an assigned user account in both collaborative scheduling product 104 and virtual travel mileage server 102. An administrator or approver may have login read and write privileges to all accounts in virtual travel mileage server 102. An administrator or approver may or may-not schedule conferences on the collaboration scheduling product 104.

The components of the system of the present disclosure, for example, the user 108, the administrator and/or approver 110, collaboration scheduling product 104 and virtual travel mileage server 102 may communicate via the Internet 112 using, for example, World Wide Web access. It should be understood that any other communication means and medium, including but not limited to LAN, WAN, wireless RF, wired communications may be utilized.

The virtual travel mileage server 102 may include a Web server 124, program logic 122 and a database server 120. The virtual travel mileage server 102 manages a database of user accounts (e.g., in its database server 120) and maintains a communication path to collaborative scheduling products, for example, using the Internet connection 112. Any other communication means or medium may be utilized to maintain the communication path to collaborative scheduling products, including but not limited to WAN, LAN, wireless or wired, etc. The virtual travel mileage server 102 also manages a database of company and employees' accounts (e.g., in the database server 120), for example, a list of rewards that are pending approval for each employee, tabulation of rewards accrued by each employee less redeemed rewards, redemption of rewards. The virtual travel mileage server 102 also calculates carbon credits for each member company. The virtual travel mileage server 102 also manages a communications path to a rewards redemption center. A rewards redemption center may be a clearing house that allows a user to acquire desired merchandise or products in exchange for the points earned, i.e., to redeem the points for awards. A business relationship may be maintained with such redemption centers.

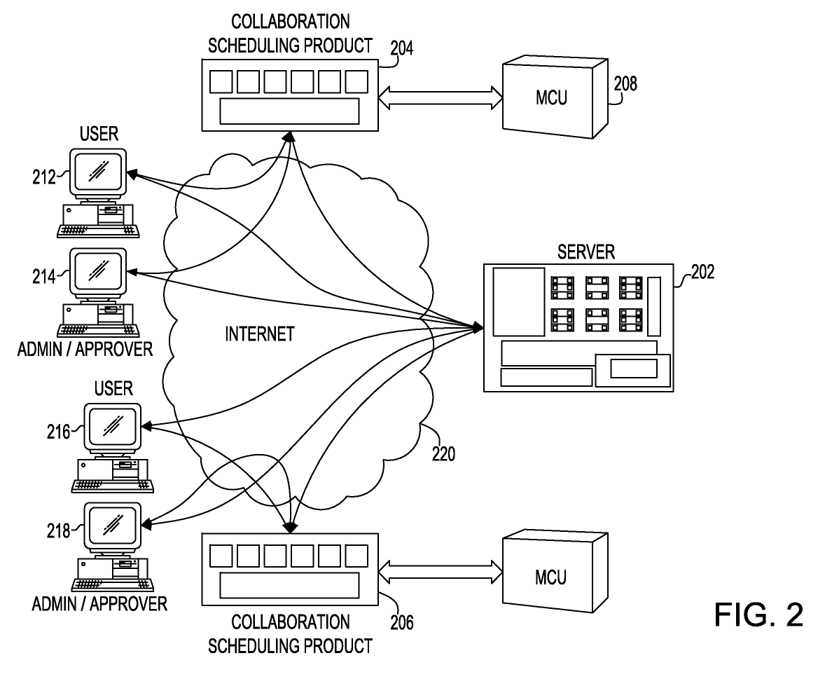

FIG. 2 is another architectural diagram in one embodiment showing multiple collaboration scheduling products or platforms 204, 206 working in conjunction with a single virtual travel mileage computer server or platform 202. While only two collaboration scheduling products or platforms are shown it should be understand that any number of such products may register with the virtual travel mileage server 202. For instance, a plurality of companies each may register one or more of their collaboration scheduling products with the virtual travel mileage server 202. A user 212 and an administrator 214 associated with one company may schedule conferences and keep track of virtual travel mileage on their collaborative scheduling product 204 and MCU 208 via the virtual travel mileage server 202, while a user 216 and an administrator 218 of another company also may schedule conferences and keep track of virtual travel mileage on their corresponding collaborative scheduling product 206 and associated MCU 210 via the virtual travel mileage server 202. This approach affords an efficient and cost effective solution to support a rewards program that enables multiple companies to register their collaborative scheduling product to a single virtual travel mileage platform.

A universal account concept designed in virtual travel mileage affords added flexibility to individual employees' accounts. This means that when an employee moves from one employer to another, if the new employer participates in virtual travel mileage, then the employee's account may be moved to the new employer's corporate account. For example, virtual travel mileage server 202 may maintain accounts for multiple corporations and if an employee moves to another company registered within the virtual travel mileage system, that employee's data may be transferred to his or her new company's data seamlessly by the virtual travel mileage server 202.

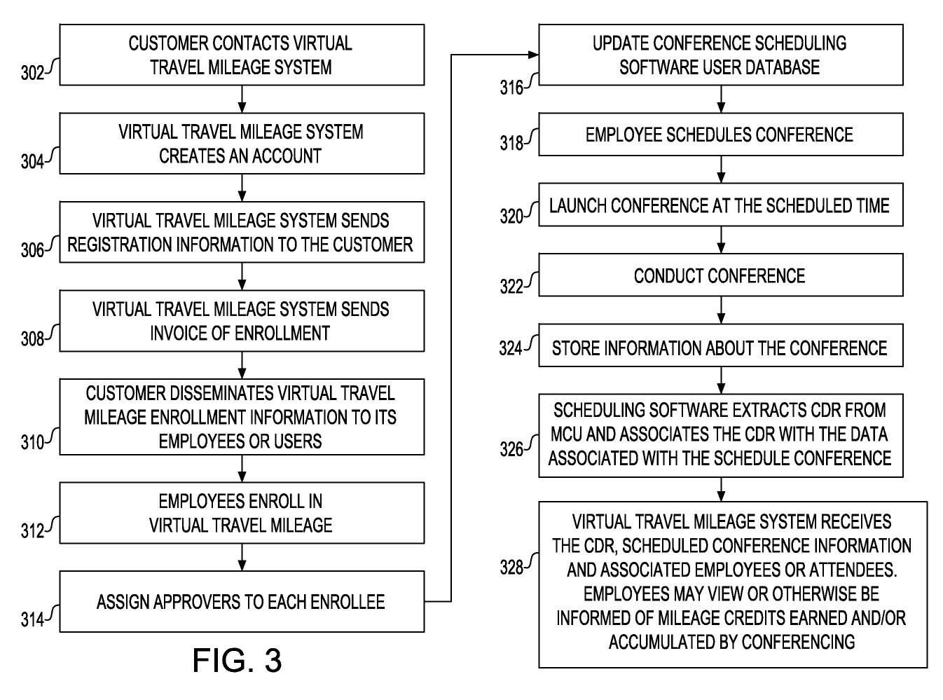

FIG. 3 is a flow diagram illustrating a method of the present disclosure in one embodiment. At 302, a company, for example, a customer of virtual travel mileage system contacts the virtual travel mileage system to set-up a corporate virtual travel mileage account. For instance, the company (e.g., a person representing the company) may browse a web site associated with the virtual travel mileage system and make a request via the web site. For example, the server (102) shown in FIG. 1 may provide a web server for supporting such web sites. The company may also email a request to a virtual travel mileage system customer support, and/or telephone the customer support to request an account setup. Any other methodology may be employed to initiate a contact and set up an account with the virtual travel mileage system of the present disclosure.

At 304, virtual travel mileage customer support creates a corporate account, for example, by filling-in the information such as the following: company name, company address, company city, company state, company zip code, billing address, billing city, billing state, billing zip code, company marketplace, list of all company locations participating in the program, corporation identification (ID) number (auto-generated), company contact information—name, title, department, email address, company phone number, number of corporate participants permitted to enroll into the virtual travel mileage system, virtual travel mileage authorizers per department name, title, department, email address and company phone number. The above list of information is shown as examples only. Not all or additional information may be acquired by the virtual travel mileage system or provided by the customer, and/or different information may be acquired.

At 306, information such as enrollment instructions, rules, regulations and program agreement, login and password and secure link are emailed to the company contact. In one aspect, to provide security and secure transactions, the link in the email may be the only manner in which the contact can access the page to complete the account information. The company contact may enter a password of his or her choice before account information is accepted. This helps to validate the account. In response to the account being created, for example, at the conclusion of the account creation, an email is sent to company contact verifying the completion of the company information. In one embodiment, in the email there is provided the corporate ID that is to be used by all employees to indicate and certify the company under which the user is enrolling in virtual travel mileage.

At 308, an invoice for the corporate enrollment into virtual travel mileage is sent to the enrolling company. At 310, a company representative disseminates information about the virtual travel mileage system, for example, virtual travel mileage Web site information to the employees of the enrolling company. At 312, employee having access of scheduling software enroll in virtual travel mileage, for instance, by providing the following information: employee name, home street address, home city, home state, home zip code, employee's company information (e.g., company street address, city, state, zip code, department), Electronic mail (email), secondary email, height, weight, department or departments within a company to which an administrator or approver 110 is assigned authority to the approval processes for the people within those departments, primary vehicle make and model, mileage to workplace, mileage to airport from home and from workplace, and user ID number. A user ID number refers to a unique identification number automatically generated for each user 108 and approver 110, for instance, at the time the respective person enrolls into the virtual travel mileage. The above examples are listed for illustrative purposes only, more or less than all the above information or other information may be provided. Some of the information may be used to determine carbon credits allocated as they align with the mileage credits or points accumulated.

At 314, approvers are assigned to each enrollee. Approvers, for example, may calculate mileage credits (also referred to as reward points, credit points), move the credits from pending status to an accrued status, and validate the issuance of mileage credits (or reward points).

At 316, the conference scheduling software user database is updated with virtual travel mileage user ID. The conference scheduling software may be a video conferencing software such as myVRM™.

At 318, the scheduling software user creates conferences that are scheduled and stored, for example, under “Reservations” in a secure database of the scheduling software. Scheduling a conference, for instance, creates or defines information about the conference such as conference name, unique ID, Start date and start time, end date and end time, host location, participant location(s), participants names displayed, participants' and host's virtual travel mileage ID. The information created or defined may depend on the conference scheduling device or software used. All, some or different information may be created. In one embodiment, the information may be accumulated from a user 108 accessing a web interface provided by Web services server 118 into the collaborative scheduling product 104. The logic 116 may provide the methodology of displaying the proper information to the user 108 through the Web services server 118. Upon completion of the information requested and displayed via the Web services server 118 by the logic 116, the information may be then stored in a database 114.

At 320, on the date and time appointed in the reservation details, the collaborative conference is launched by the use of the scheduling software that, for example, performs point-to-point collaborative conference, multipoint collaborative conference, or other conference. For example, after writing the conference schedule information to the database 114, the collaborative scheduling program 104 transfers the conference to the MCU 106. The logic 116 provides the instructions to assemble the information stored in the database 114 on the date and at the time designated, and initiate the conference into an ongoing state on the collaborative scheduling program server 104. Continuing to follow the programming defining the actions of the program logic 116 as established in the parameters of the scheduled conference accumulated in the database, the collaborative scheduling program server 104 is instructed to utilize the connectivity to MCU 106 to define, within the program logic of MCU 106, the information pertaining to the conference initially stored in database 114. The MCU 106 then acts upon the instructions provided by the conference information provided, and a multipoint videoconference (or other conference) is established.

At 322, the conference is conducted. At 324, at the conclusion of the conference the information regarding the locations and participants in attendance of the conference is stored in a secure scheduling software database, for instance, designed to accumulate “past” conferences. As a continuing function of the logic 116, the scheduled conference remains in an ongoing state on the collaboration scheduling product 104, and on the MCU 106, until the duration of the conference has been realized. When the conference duration has expired, the program logic 116 preserves or stores the information of the now past conference in designated fields within the database 114.

At 326, for the purposes of verification of collaborative conferencing events, call detail records (CDR) from the collaborative MCUs are extracted by the scheduling software and associated with the corresponding conferences collected in the secure scheduling software database. For example, the program logic 116 may send a request or execute a request to send to the MCU 106, through the communications link that is maintained between the collaboration scheduling product 104 and the MCU 106, for example, during the course of the program logic 116 processing, storing and/or preserving the information of the now past conference in designated fields within the database 114. The request is a series of calls for the call detail record (CDR) of the conference corresponding to the conference being saved in the database 114, as recorded in the database of the MCU 106. The program logic 116 may then combine the completed conference information from database 114 and the CDR from MCU 106 into files maintained within the database 114.

At 328, these conference detail data collected from the scheduling software and the MCU CDR for each collaborative conferencing meeting are automatically directed to the secure database. For example, once the program logic 116 combines the completed conference information from database 114 and the CDR from MCU 106 into files maintained within the database 114 at 326, the program logic 116 may execute another process. The program logic 116 “listens” for requests, for example, as presented by logic 122 operating through a link established between the collaborative scheduling server 104 and the virtual travel mileage server 102. The requests from logic 122 seeks from the database 114 information regarding completed conferences that reside in database 114 that (1) are conferences defined to belong to companies and employees found in the company/user records within database 120; and (2) are completed conferences with all records present including the CDR from MCU 106. With requests that are positively acknowledged, the logic 122 may issue a request to the program logic 116 to compile and send all records flagged as meeting the two above conditions to the logic 122 through a link established between the collaborative scheduling server 104 and the virtual travel mileage server 102. The information arriving at virtual travel mileage server 102 may be processed by the logic 122 and stored in the database 120.

The information in the database may be presented to the employee. For example, each employee scheduled to attend the conference is provided with an amount of, (if any) “miles”, i.e., virtual travel mileage credits, credited to their account relating to the conferences which they attended. Any algorithm or formula may be used to compute or correlate the virtual travel mileage credits by conducting the audio/video conference instead of traveling. Such algorithm or formula may be based on a company policy, design choice, etc. As an example, virtual travel mileage credits may be computed by (1) using information of the air miles between locations and/or a typical or average cost of a coach airline ticket to travel to the host locations related to the locations scheduled in a conference, (2) the per diem of the typical or average number of days assumed required to travel to a meeting at a remote location, (3) the average cost of the hours/days of lost productivity, (4) the typical or average charges for the typical number of nights residing in a hotel, (5) mileage, cab fares, etc. to and from airport. In one aspect, the participants at the location to which all participants would have traveled may not accrue virtual travel mileage credits for the participants attending the videoconference (or other conference) from that location. If the mode of transportation between locations is automobile, bus, train, etc. then the mileage paid per mile by car or the average cost of a bus or train ticket may be used as one facet of calculating credit. Once the cost is computed by using the above guidelines then that monetary value may be multiplied by a percentage the company participating in the virtual travel mileage program defines. The company also may define which of the items listed above or taken into account is eligible for earning rewards, and the figure derived from that calculation may define the credits earned.

An example of a computation follows. In this example, the company is only allowing reward credits to be accrued on the air fare. The percentage defined for the calculation is 5%.

| | | |
|---|---|---|
| Travel Cost | Air fare | $1,000.00 |
| | Hotel (2 nights) | 300.00 |
| | Travel (to/from airport) | 200.00 |
| | Food (3 days) | 225.00 |
| | Lost productivity | 400.00 |
| | Total Travel Cost | $2,125.00 |
| Virtual travel mileage credit | 5% of air fare to employee | $50.00 |

The virtual travel mileage credits then may be redeemed or exchanged with rewards such as physical rewards including but not limited to products, merchandise, trips, or even cash. A redemption center, for instance, that has a relationship with the company may be used in the reward redemption process.

For computing the carbon credit accrual for the companies: As of January 2009, approximately $1,000 in air travel savings equates to approximately $40.00 in carbon offset.

Carbon credit may be computed using the data collected from the conferencing and one or more algorithms. Algorithms for computing carbon credits are generally based on the rules and/or policies established by one or more governing bodies that oversee the carbon credit trading schemes. Such governing bodies may include but are not limited to Chicago Climate Exchange, Montreal Climate Exchange and European Climate Exchange. The data collected in the present disclosure from the conferencing devices are used to properly convert or generate carbon credits that can be accrued to the company by having its employees or the like use conferencing instead of traveling.

The secure database may support the virtual travel mileage Web site, for example, and in response to the employee accessing the Web site, the employee may be enabled to view or otherwise be informed of his or her current virtual travel mileage credits via one or more web pages presented by the Web site.

In one embodiment, each approver may receive, at the end of each month, an email notice of the need to approve pending virtual travel mileage rewards. In one embodiment, only those rewards pending approval may be displayed. Hierarchical approval processes may be defined. For example, depending on the authorities defined by participating companies, for each person that approves the accrual of rewards by company employees, there may be a checks-and-balances process that requires, for example, a manager to approve certain employees, but a director to whom the manager reports may be required to endorse the manager's approvals. Such procedure is illustrated only as an example, and is not required.

Monthly reports may be made available for the program administrator as follows: for each employee, rewards pending from the prior month(s); for each employee, total rewards accumulated year-to-date; for company off-set credits calculated from the total amount of travel saved by the employees during the previous month; for company off-set credits calculated from the total amount of travel saved by the employees year-to-date. The reports may provide multiple layers of information that can be utilized to define the eligibility of the rewards and to define carbon credits.

The system and method of the present disclosure can quantify virtual travel mileage, for example, by determining the amount of savings that resulted from not having to actually travel by instead conducting an audio and/or video conference, and convert those savings into redeemable awards for the employees as well as employers. The system and method of the present disclosure, in one aspect, thus define virtual rewards miles.

While the system and method of the present disclosure is illustrated above with reference to multipoint conferences, it is not limited to only such conferences. Rather, point-to-point video and/or audio conferences and others conferences may be utilized and managed as well. Further, while the examples illustrated with reference for FIGS. 1, 2 and 3 refer to multi-point conference devices, it should be understood that the system and method of the present disclosure may be implemented, utilized and/or used with other conferencing devices and software or the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for quantifying and using virtual travel mileage, comprising:
automatically collecting, by a conference scheduling device, call detail records of a conferencing session from a collaborative multipoint conference unit;
associating the call detail records to one or more of a plurality of conference attendees in the conferencing session;
converting the call detail records associated with said one or more of a plurality of conference attendees into mileage credit; and
establishing rewards to said one or more of a plurality of conference attendees based on the mileage credit.

2. The method of claim 1, wherein the step of converting and the step of establishing are performed in a computer server separated from said conference scheduling device and said collaborative multipoint conference unit.

3. The method of claim 2, wherein said computer server maintains a database of accounts including mileage credit information for a plurality of users conducting conferencing sessions over a plurality of conference scheduling devices and a plurality of collaborative multipoint conference units.

4. The method of claim 3, wherein said computer server automatically receives said call detail records from said plurality of conference scheduling devices.

5. The method of claim 4, further including:
presenting said mileage credit, rewards, or combinations thereof to a user.

6. The method of claim 4, further including:
presenting said mileage credit, rewards, or combinations thereof via a web page.

7. The method of claim 4, further including:
providing reports periodically of said mileage credit, rewards, or combinations thereof.

8. The method of claim 1, further including:
determining carbon credits earned by an employer of said one or more of a plurality of conference attendees.

9. A method for quantifying and using virtual travel mileage, comprising:
automatically collecting data associated with a conferencing session by a computer communicating with a collaborative conferencing device, said data including at least call detail records of the conferencing session;
converting said collected data into mileage credits; and
establishing rewards in exchange with said mileage credits.

10. The method of claim 9, wherein the step of converting includes converting said collected data into carbon credits.

11. A program storage device readable by a machine, tangibly embodying a program of instructions executable by the machine to perform a method of quantifying and using virtual travel mileage, comprising:
automatically collecting data associated with a conferencing session, said data including at least call detail records of the conferencing session;
converting said collected data into mileage credits;
establishing rewards in exchange with said mileage credits.

12. The program storage device of claim 11, wherein the step of converting includes converting said collected data into carbon credits.

13. A program storage device readable by a machine, tangibly embodying a program of instructions executable by the machine to perform a method of quantifying and using virtual travel mileage, comprising:
automatically collecting, by a conference scheduling device, call detail records of a conferencing session from a collaborative multipoint conference unit;
associating the call detail records to one or more of a plurality of conference attendees in the conferencing session;
converting the call detail records associated with said one or more of a plurality of conference attendees into mileage credit; and
establishing rewards to said one or more of a plurality of conference attendees based on the mileage credit.

14. The program storage device of claim 13, wherein the step of converting and the step of establishing are performed in a computer server separated from said conference scheduling device and said collaborative multipoint conference unit.

15. The program storage device of claim 14, wherein said computer server maintains a database of accounts including mileage credit information for a plurality of users conducting conferencing sessions over a plurality of conference scheduling devices and a plurality of collaborative multipoint conference units.

16. The program storage device of claim 15, wherein said computer server automatically receives said call detail records from said plurality of conference scheduling devices.

17. The program storage device of claim 16, further including:
presenting said mileage credit, rewards, or combinations thereof to a user.

18. The program storage device of claim 16, further including:
presenting said mileage credit, rewards, or combinations thereof via a web page.

19. The method of claim 16, further including:
providing reports periodically of said mileage credit, rewards, or combinations thereof.

20. A system for quantifying and using virtual travel mileage, comprising:
one or more collaborative conference units operable to maintain a conferencing session;
one or more conference scheduling devices operable to automatically collect call detail records of a conferencing session from one or more of the collaborative conference units; and
a computer server operable to automatically receive data associated with said call detail records and convert the data into mileage credits.

21. The system of claim 20, wherein the computer server is further operable to convert the data into carbon credits.

22. The system of claim 20, wherein the computer server is further operable to associate the data with one or more of a plurality of conference attendees of the conferencing session and accrue mileage credit points for said one or more of a plurality of conference attendees.

23. The system of claim 22, wherein the computer server is further operable to establish rewards to at least one of said plurality of conference attendees based on the mileage points.

24. The system of claim 20, further including:
database storage operable to store said call detail records and user accounts associated with the plurality of conference attendees.

25. The system of claim 20, wherein the computer server further includes a web server operable to maintain a web site for allowing said plurality of conference attendees to view information associated with the mileage credit and the rewards.
